(19) United States
(12) Patent Application Publication
(10) Pub. No.: US 2017/0091785 A1
(43) Pub. Date: Mar. 30, 2017

(54) RELIANCE MEASUREMENT TECHNIQUE IN MASTER DATA MANAGEMENT (MDM) REPOSITORIES AND MDM REPOSITORIES ON CLOUDED FEDERATED DATABASES WITH LINKAGES

(71) Applicant: International Business Machines Corporation, Armonk, NY (US)

(72) Inventors: Ajay Arangali Raghavan, Eagan, MN (US); Ganesh Boggaram, Bangalore (IN); Ankur B. Shah, Surat (IN)

(21) Appl. No.: 14/864,537

(22) Filed: Sep. 24, 2015

(51) Int. Cl. G06Q 30/02; G06F 21/62; G06F 17/30

(52) U.S. Cl. CPC G06Q 30/0201; G06F 17/3053; G06F 17/30383; G06F 21/6245

(57) ABSTRACT

Provided are techniques for determining trustworthiness of data. Each customer record is assigned a single customer view identifier in a master data management repository. Linkages are used to determine one or more suspect records for each customer record. A score is assigned to each customer record based on the linkages to the one or more suspect records, tag information associated with each customer record, and configuration information. A heat map is generated to provide an indication of trustworthiness of the multiple records based on the reputation score associated with the origin of each record.

### FIELD

Embodiments of the invention relate to determining trustworthiness of data. In particular, embodiments of the invention relate to a reliance measurement technique in Master Data Management (MDM) repositories and MDM repositories on clouded federated databases.

### BACKGROUND

A Master Data Management (MDM) system offers organizations the opportunity to use an MDM platform to extract insight from a variety of data. For example, a company may gain insight into customer behavior and product sentiment by performing analytics on large volumes of data from a variety of sources, such as website logs and social media websites. Similarly, the same company may leverage the same platform to gain insight into user activities and potential security threats by performing analytics on large sets of audit data from numerous sources, such as database logs, operating system logs, application server logs, and Customer Relationship Management (CRM)/Enterprise Resource Planning (ERP) application logs.

The MDM platform is a promising technology for extracting knowledge and insight from large volumes and variety of data. However, this insight is only as good as the data from which it is extracted. In other words, the weakest point in the insight extraction process remains the relevance and trustworthiness of the input data, which may be from uncertain and/or unverified origins. This makes the old computer science concept of “garbage in, garbage out” a primary concern for MDM analytics.

This issue has not been properly addressed by the MDM research and development community. The MDM platform is an emerging technology and most of the work that has been done so far has focused on providing the tools and infrastructure for effective large -scale storage and analytics processing.

### SUMMARY

Provided is a method for determining trustworthiness of data. The method comprises assigning each customer record a single customer view identifier in a master data management repository; using linkages to determine one or more suspect records for each customer record; assigning a score to each customer record based on the linkages to the one or more suspect records, tag information associated with each customer record, and configuration information; and generating a heat map to provide an indication of trustworthiness of the multiple records based on the reputation score associated with the origin of each record.

Provided is a computer program product for determining trustworthiness of data. The computer program product comprises a computer readable storage medium having program code embodied therewith, the program code executable by at least one processor to perform: assigning each customer record a single customer view identifier in a master data management repository; using linkages to determine one or more suspect records for each customer record; assigning a score to each customer record based on the linkages to the one or more suspect records, tag information associated with each customer record, and configuration information; and generating a heat map to provide an indication of trustworthiness of the multiple records based on the reputation score associated with the origin of each record.

Provided is a computer system for determining trustworthiness of data. The computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform: assigning each customer record a single customer view identifier in a master data management repository; using linkages to determine one or more suspect records for each customer record; assigning a score to each customer record based on the linkages to the one or more suspect records, tag information associated with each customer record, and configuration information; and generating a heat map to provide an indication of trustworthiness of the multiple records based on the reputation score associated with the origin of each record.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates an example MDM mapping console in accordance with certain embodiments.

FIG. 3 illustrates example hash tables in accordance with certain embodiments.

FIG. 4 illustrates an example data heat map in accordance with certain embodiments.

FIG. 5 illustrates links in accordance with certain embodiments.

FIG. 6 illustrates, in a flow chart, operations performed in accord with certain embodiments.

FIG. 7 illustrates a cloud computing node in accordance with certain embodiments.

FIG. 8 illustrates a cloud computing environment in accordance with certain embodiments.

FIG. 9 illustrates abstraction model layers in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

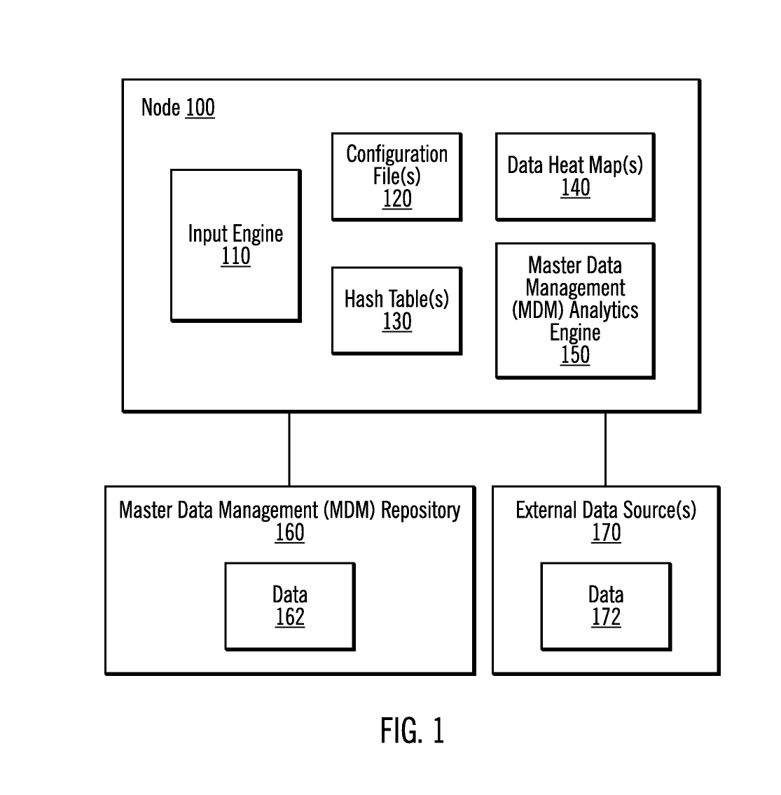

FIG. 1 illustrates, in a block diagram, a computing environment in accordance with certain embodiments. A node 100 is coupled to a Master Data Management (MDM) repository 160 for storing data (e.g., records) and to one or more external data sources 170 (that are external to the MDM repository 160) for storing data (e.g., records). The node 100 is part of an MDM cluster. In certain embodiments, there are many nodes coupled to each other that are part of the MDM cluster. The computing device 100 includes an input engine 110, one or more configuration files 120 storing configuration information, one or more hash tables 130, one or more data heat maps 140, and an MDM analytics engine 150. The MDM repository 160 stores data 162, and each of the one or more external data sources 170 stores data 172.

The input engine 110 allows a customer to gain insight into the trustworthiness of the data lying in the MDM repository.

The input engine 110 ranks and classifies the relevance and trustworthiness of the data.

stored in the MDM repository and other sources, effectively producing a data heat map that ultimately boosts the customers' confidence level in the analytics provider.

The input engine 110 extends the data ingest process to automatically associate tag information (“tag” or “label”) with every piece of data as it is ingested into the MDM repository, and then leverages that tag in producing a data heat map representing the trustworthiness of the data stored in that repository. At a minimum, this tag includes the origin of the data, along with the date and the time that the data was ingested into the MDM repository. The origin may be a multi-attribute data structure that consists of the identity of that origin (e.g., User A, System A), the type of that origin (e.g., a blog, source System A), and a pointer to the actual origin (e.g., a Uniform Resource Locator (URL)).

To produce the data heat map, the input engine 110 presents an interface (e.g., a

Graphical User Interface (GUI)) in which the customer enters some configuration information. This interface is referred to as the MDM mapping console.

The configuration information includes three elements: 1) the domain or question of interest; 2) the reputation of the origin of the data; and 3) relevance of the age of the data.

For example, the domain or question of interest may be: “what are the advantages of Database A's Security?”

With reference to the reputation of the origin of the data, the customer may see a view of all the origin types from which the data was acquired with a default reputation assigned to each. The customer has the opportunity to update the reputation value for a particular origin. This may be done for a specific origin identity or for an origin type as a whole. The reputation assignment may be a value on a scale from 1 to 10. For example, a customer may say that data that originates from the DatabaseX data center is sufficiently trusted, but given that it is the vendor's web site, the customer assigns a value of 7 to this data. On the other hand, data that originates from a competitor's web site is probably a bit biased, and the customer assigns to it a value of 5 to this data. At the same time, data that originates from the website of Research Lab Z is highly trusted, so this data is assigned a value of 9.

With reference to the relevance of the age of the data, the customer may say that data older than five years is not relevant and assigns to this data a value of 2 on a 1 to 10 scale. On the other hand, any data less than five years old is relevant, and the customer assigns to this data a value of 8 on the same scale.

With embodiments, the reputation and/or the age configuration information may be provided. As newer data is received, the age relevancy is automatically updated for the data by the input engine 110.

The customer may choose to produce a heat map based on reputation only, on age only, or on both reputation and age. When both are entered, the customer has the opportunity to assign weights to each. By default, both have an equal weight of 50%. Finally, the customer has the opportunity to configure the desired scores for the high, medium, and low trust levels. By default, a score greater than or equal to 8 is considered high, a score between 5 and 7 is considered medium, and a score less than or equal to 4 is considered low.

At this point, the customer launches the input engine 110 to produce the data heat map. The input engine 110 scans the data and computes the scores based on the data tags and the configuration information above. The input engine 110 takes advantage of the MDM Map/Reduce technology to speed up execution through parallelization. When this process completes, the input engine 110 produces a view showing the data distribution based on the high, medium, and low trust levels.

The input engine 110 allows a customer to gain insight into the trustworthiness of all the data lying in the company's MDM repository. For example, the customer may choose to throw away non-trusted data and save storage space. The MDM analytics engine 150 may choose to use the data tags and trustworthiness classification to consider just highly trusted data to increase the customers' confidence level in the insight extracted.

The data tags may be used to complement MDM analytics engine security by offering a label based access control mechanism. For example, audit logs from the payroll database may contain highly sensitive data and access should be provided to authorized personnel only. In other words, sensitive data should not lose its security just because it was copied to an MDM repository.

The following example embodiment is provided to enhance understanding. In this example, a car manufacturer has just released a new high-end model to try to take market share from one of its top competitors. The manufacturer would like to gain insight into customer sentiments about the new model, so the manufacturer decides to leverage the company's MDM repository, where they have collected and stored volumes of data from various sources. The vice president of marketing has some concerns about the trustworthiness of the data stored in the MDM repository and asks to see a data heat map showing data distribution across three levels of trust: High, Medium, and Low. The MDM System Administrator (“SA”) is charged with this task.

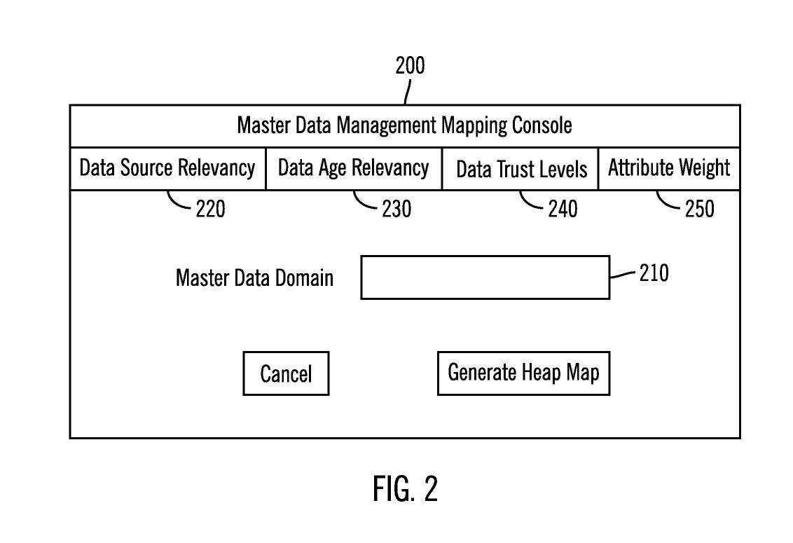

FIG. 2 illustrates an example MDM mapping console 200 provided by the input engine 110 in accordance with certain embodiments. In certain embodiments, using the input engine 110, the SA launches the MDM mapping console 200. The SA first enters the domain area question in “Master Data Domain” box 210. In this particular case, the SA enters: “What are the advantages of <brand name><model name>?”.

The MDM mapping console 200 includes a “Data Source Relevancy” tab 220, a “Data Age Relevancy” tab 230, a Data Trust Levels” tab 240, and an “Attribute Weight” tab 250.

After entering the master data domain, the SA configures the reputations for the data origins (if this has not been done already). For the sake of this example, assume that the data comes from three major source origins: social media website A posts, social media website B posts, and car review magazine sites. Using the data heat map management console 200, the SA selects the “Data Source Relevancy” tab 220. For social media website A posts, the SA assigns a score of 3 to the whole group. For social media website B posts, the SA also assigns a score of 3 to the whole group, but decides to assign a score of 8 to specific posts from User X, as User X is a highly respected authority on car reviews. For car magazine sites, the SA assigns a score of 6 to the whole group, but decides to assign a score of 8 to articles from a well-respected car review magazine.

The SA decides that the age of the data does not matter since the new model has just been released and all the data is fairly relevant from an age perspective. The SA does not change the default setting for the “Data Age Relevancy” tab 230, which indicates that data age is not relevant. Similarly, the SA decides to leave the default settings for the “Data Trust Levels” tab 240. In this example, by default, a score greater than or equal to 8 is considered high, a score between 5 and 7 is considered medium, and a score less than or equal to 4 is considered low. After selecting the “Attribute Weight” tab 250, the SA updates the relative weights of the reputation and age attributes are such that the weight of the age attribute is set to zero and the weight of the reputation attribute is set to one. Again for this example, the age of the data was deemed not relevant.

At this point, the SA clicks on the “Generate Heat Map” button. This launches the process to compute and show the data heat map. First, if a domain area question has been provided, the MDM analytics engine 150 uses text analytics to determine the subset of data that is relevant to that question. Otherwise, all data is considered.

Second, for each relevant piece of data, the input engine 110 consults the associated tag and determines a score based on the data in that tag and the configuration information that was entered. In general, the score S of a piece of data is computed as S=W_1×Attr_1+W_2×Attr_2+ . . . +W_n×Attr_n , where W_i (1<=i<=n) is the relative weight of attribute Attr_i (1<=i<=n), and n is the total number of attributes being considered. So, for our example, the score “S =1 x reputation” since only the reputation attribute is being considered. Depending on the value of S, the count of the low, medium, or high trust levels is incremented by one. A three elements' hash tables representing the low, medium, and high trust levels are used to keep track of the respective counts. This processing may be done in parallel to take advantage of the distributed nature of the MDM platform and accelerate the computation of the data heat map. In this case, each node in the MDM cluster computes a partial hash table, and one node performs the final aggregation.

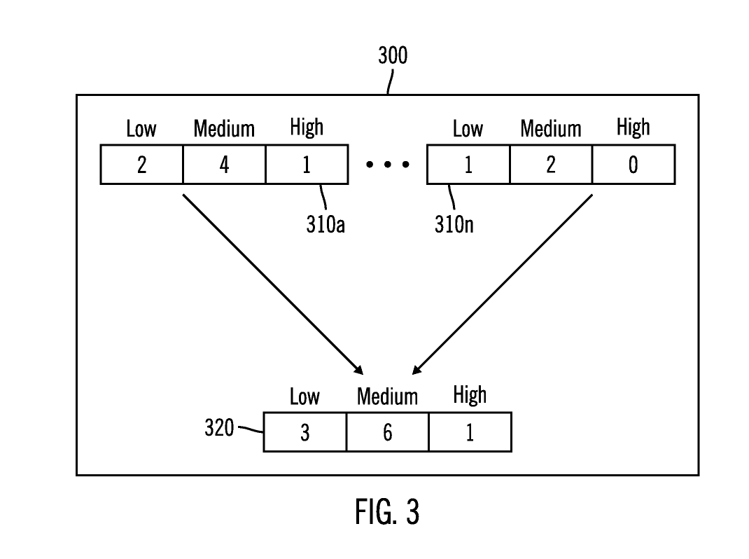

FIG. 3 illustrates example hash tables 300 in accordance with certain embodiments. In particular, the input engine 110 at each node in the MDM cluster computes a partial hash table 310a . . . 310n, and the input engine 110 at one node in the MDM cluster performs the final aggregation to obtain a final hash table 320.

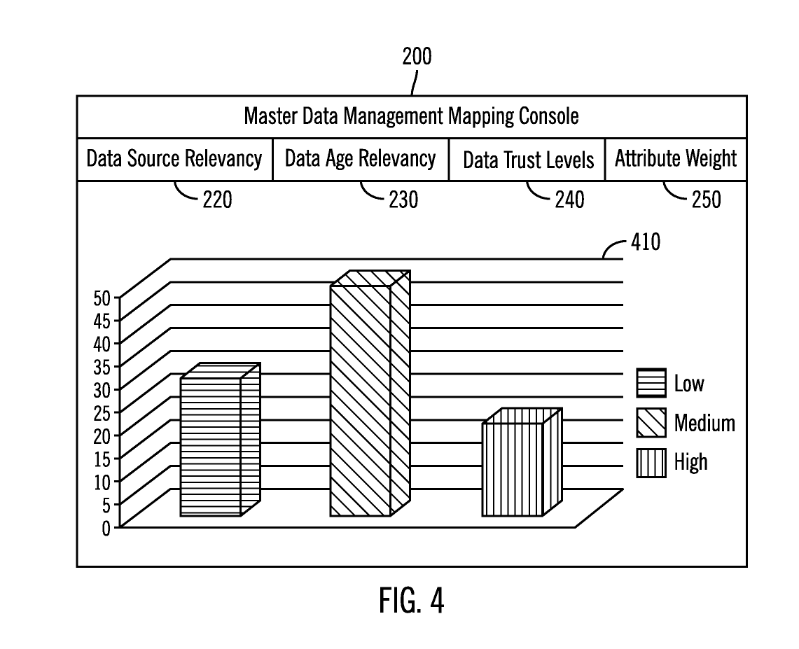

Third, when the process completes, the input engine 110 presents the data heat map. FIG. 4 illustrates an example data heat map 400 in accordance with certain embodiments. The data heat map 400 has been generated based on the input provided via the Data Source Relevancy” tab 220, the “Data Age Relevancy” tab 230, the Data Trust Levels” tab 240, and/or the “Attribute Weight” tab 250.

Thus, the input engine 110 extends the data ingest process to automatically associate a tag (or label) with every piece of data as that is ingested into the MDM repository, and then leverages that tag in producing a data heat map representing the trustworthiness of the data stored in that repository. The data tags themselves do not represent trust levels. They represent data origins and other optional attributes, such as age, etc. All the MDM SA has to do is configure how trust levels are derived from data origins and the other optional attributes. Typically, this configuration would need to be done once and updated only as needed.

Also, with embodiments, the score is captured at record level. Embodiments can then compute a distribution better reflecting the whole system, such as the proportion of records with low confidence, the proportion with high confidence, etc.

This may go beyond and can be also implemented in clouded federated database.

### Linking

The MDM analytics engine helps enterprises create trusted insight as the volume, velocity, and variety of data continue to explode. The MDM analytics engine offers several solutions designed to help organizations uncover previously unavailable insights and use them to support and inform decisions across the business. Combining the power of the MDM analytics engine with a big data portfolio creates a valuable connection: big data technology may supply insights to the MDM analytics engine, and the MDM analytics engine may supply master data definitions to the big data technology. In certain embodiments, the MDM analytics engine provides the golden copy of the data (e.g., customer record) using analytics to derive conclusions with a high level of confidence.

Such MDM analytics engine-big data technology solutions provide a single, trusted view of business entities, such as customers, suppliers, products, and accounts. These solutions manage business entities centrally, eliminating reliance on incomplete or duplicate data.

The MDM analytics engine helps businesses to: consolidate data across their organization, share key data elements among their affiliated entities, and enable collaborative authoring of data across business.

When data comes into the MDM repository, if the data is similar to data stored, then, that data is referred to as a suspect (e.g., a social security number and name of a person are already stored as a record). The data is structured as records (e.g., rows in a table having columns) and is specific to a domain. There are different tables for different domains.

The data that is most trusted for a customer is referred to as the “golden copy” (e.g., name, address, phone number, driver's license number, passport number, social security number, etc.).

When data comes in, the MDM engine determines whether there is a match between the received data and existing records and determines how closely there is a match with an existing record. For example, if the address is missing from the new data, then the address is “suspect” data. If there is a close match between records, the MDM engine merges the new data with the existing record. If there is not a close match, the MDM engine adds a new record for the newly received data. In certain embodiments, if the score for matching records is above a first threshold, the MDM engine finds that there is a match and the records are merged; if the score is below a second threshold, the MDM engine finds that there is no match, and the new data is used to create a new record; and, if the score is between the first threshold and the second threshold, the MDM engine issues a report to the business user to request instructions on how to process this record.

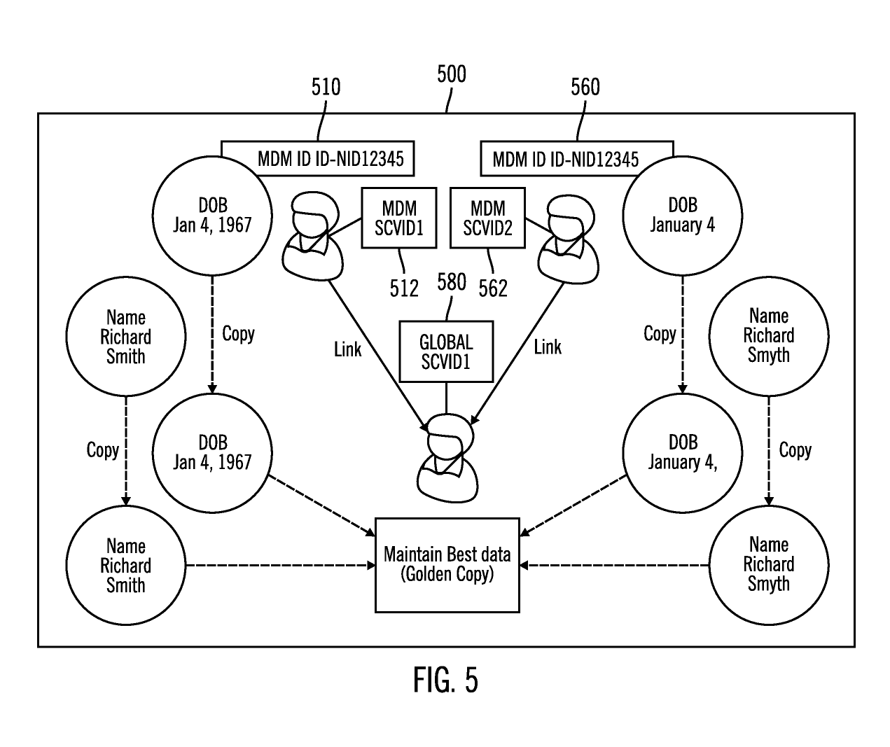

FIG. 5 illustrates links 500 in accordance with certain embodiments. With embodiments, each customer is stored in an MDM repository with an MDM Identifier (ID) and is assigned one Single Customer View ID (SCVID) once the suspects are populated in the MDM repository. With embodiments, existing data may be considered suspect with respect to newly received data. Embodiments allow linkage of suspects against the source data in external data sources (from outside of the MDM repository). Embodiments perform linking activity against suspect duplicates.

As an example, different government departments store data about a person. The data about the person may be linked via some common data (e.g., social security number or passport identifier) across many data sources (e.g., the MDM repository and external data sources).

Such linking shows users the best data from the source data and suspect data in the MDM repository. The MDM system administrator may change the data and may change an indication of whether the data is suspect manually in the best data. Once the best data is retrieved, then embodiments complete the linking process. The linking will not collapse these existing customer records into new customer records, but will link old customer records with the new golden copy customer record, which has trusted information already. Certain embodiments do not create a new record of a golden copy. When this linkage is done, the SCVID of the suspect record is updated to source SCVID. Along with this, a counter is maintained of how many such suspect records are linked to that golden copy customer record. The counters are available with a hyperlink or collapse and, when selected, will drill down to each suspect record for inquiry.

In certain embodiments, the golden copy of the customers is known by on SCVID that is assigned during the linking process. This linking process is helpful when there are duplicates across the countries and across the source system. This will also allow for one integration point to a clouded federated database, which eventually may be used with the MDM repository to extend scalability and support.

With such embodiments, the customer records are alive in the MDM repository. This is very useful for those clients that have duplicates across the country and source system. The user may view old data as well as a golden copy of the data before sending approval on the golden copy. The source system may fetch old data of customer records. Also, unnecessary data in the MDM repository is minimized.

With embodiments, the MDM engine assigns scores to the records based on the links to suspect records.

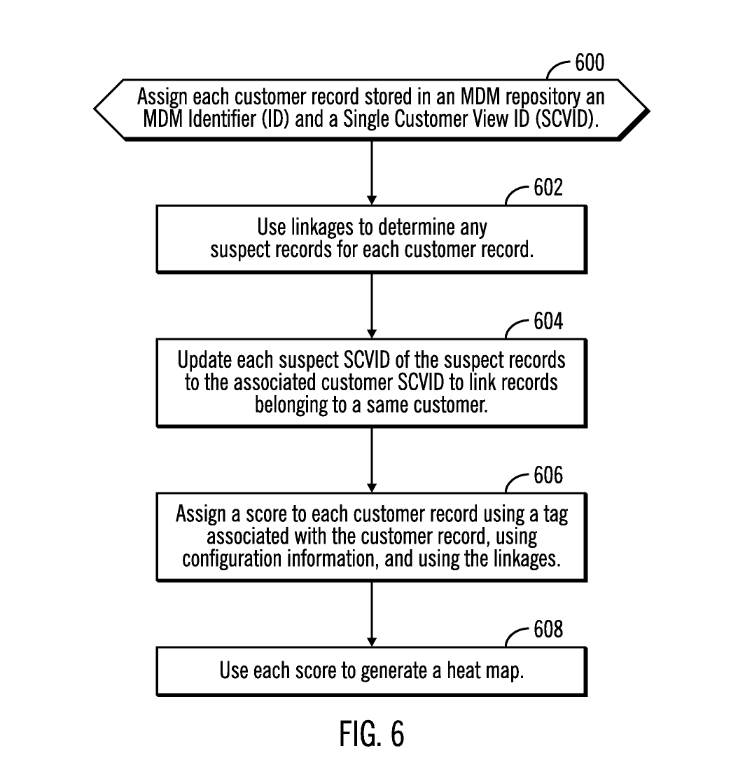

FIG. 6 illustrates, in a flow chart, operations performed in accord with certain embodiments. Control begins at block 600 with the MDM analytics engine 150 assigning each customer record stored in an MDM repository an MDM Identifier (ID) and a Single Customer View ID (SCVID). For example, in FIG. 5, one customer record is assigned an MDM ID ID-NID12345 510 and a MDM SCVID1 512, while another customer record is assigned an MDM ID ID-NID12345 560 and a MDM SCVID2 562. In block 602, the MDM analytics engine 150 uses linkages to determine any suspect records for each customer record. For example, in FIG. 5, the linkages 514 and 564 are displayed. In block 604, the MDM analytics engine 150 updates each suspect SCVID of the suspect records to the associated customer SCVID to link records belonging a same customer. For example, in FIG. 5, MDM SCVID1 512 is also the global SCVID1 580. Thus, the customer record for Richard Smith, born Jan. 4, 1967 is linked with the customer record for Richard Smyth born January 4.

In block 606, the MDM analytics engine 150 assigns a score to each customer record using a tag associated with the customer record, using configuration information, and using the linkages. In certain embodiments, this tag includes the origin of the data, along with the date and the time that the data was ingested into the MDM repository. In certain embodiments, this configuration information includes: 1) the domain or question of interest; 2) the reputation of the origin of the data; and 3) relevance of the age of the data. In certain embodiments, the linkages describe the match and link attributes (e.g., name, address, Social Security Number (SSN), email, phone, etc. In certain embodiments, depending upon the tag, the configuration information and/or the linkages and updates on these, the MDM analytics engine 150 increases and decreases the score. In block 608, the MDM analytics engine 150 uses each score to generate a heat map.

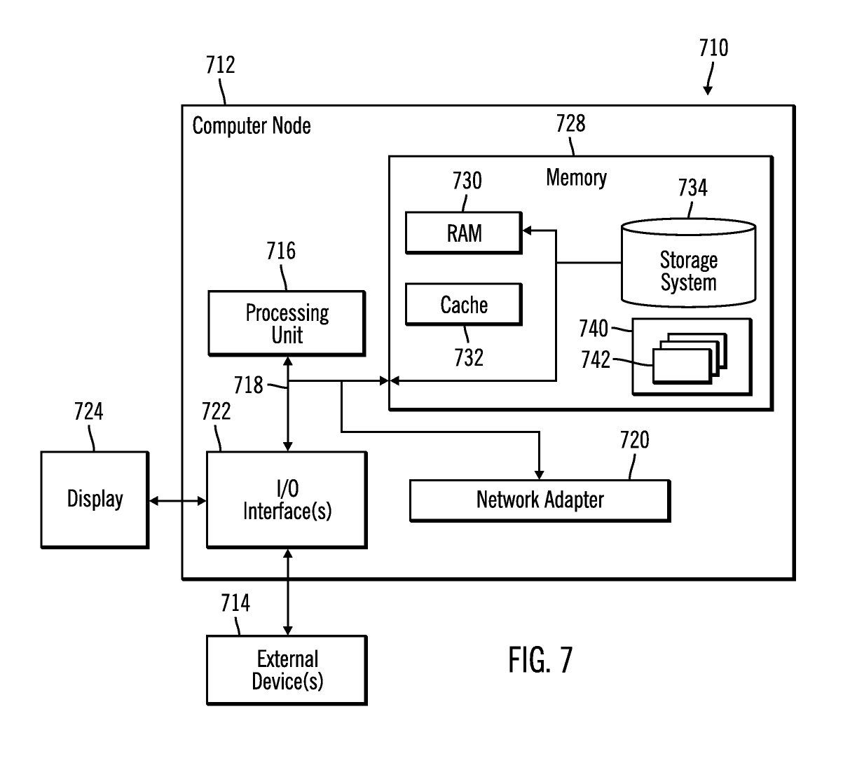

Referring now to FIG. 7, a schematic of an example of a cloud computing node is shown. Cloud computing node 710 is only one example of a suitable cloud computing node and is not intended to suggest any limitation as to the scope of use or functionality of embodiments of the invention described herein. Regardless, cloud computing node 710 is capable of being implemented and/or performing any of the functionality set forth hereinabove.

In cloud computing node 710 there is a computer system/server 712, which is operational with numerous other general purpose or special purpose computing system environments or configurations. Examples of well-known computing systems, environments, and/or configurations that may be suitable for use with computer system/server 712 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 712 may be described in the general context of computer system executable instructions, such as program modules, being executed by a computer system. Generally, program modules may include routines, programs, objects, components, logic, data structures, and so on that perform particular tasks or implement particular abstract data types. Computer system/server 712 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 712 in cloud computing node 710 is shown in the form of a general-purpose computing device. The components of computer system/server 712 may include, but are not limited to, one or more processors or processing units 716, a system memory 728, and a bus 718 that couples various system components including system memory 728 to processor 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 712 typically includes a variety of computer system readable media. Such media may be any available media that is accessible by computer system/server 712, and it includes both volatile and non-volatile media, removable and non-removable media.

System memory 728 can include computer system readable media in the form of volatile memory, such as random access memory (RAM) 730 and/or cache memory 732. Computer system/server 712 may further include other removable/non-removable, volatile/non-volatile computer system storage media. By way of example only, storage system 734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 718 by one or more data media interfaces. As will be further depicted and described below, memory 728 may include at least one program product having a set (e.g., at least one) of program modules that are configured to carry out the functions of embodiments of the invention.

Program/utility 740, having a set (at least one) of program modules 742, may be stored in memory 728 by way of example, and not limitation, as well as an operating system, one or more application programs, other program modules, and program data. Each of the operating system, one or more application programs, other program modules, and program data or some combination thereof, may include an implementation of a networking environment. Program modules 742 generally carry out the functions and/or methodologies of embodiments of the invention as described herein.

Computer system/server 712 may also communicate with one or more external devices 714 such as a keyboard, a pointing device, a display 724, etc.; one or more devices that enable a user to interact with computer system/server 712; and/or any devices (e.g., network card, modem, etc.) that enable computer system/server 712 to communicate with one or more other computing devices. Such communication can occur via Input/Output (I/O) interfaces 722. Still yet, computer system/server 712 can communicate with one or more networks such as a local area network (LAN), a general wide area network (WAN), and/or a public network (e.g., the Internet) via network adapter 720. As depicted, network adapter 720 communicates with the other components of computer system/server 712 via bus 718. It should be understood that although not shown, other hardware and/or software components could be used in conjunction with computer system/server 712. Examples, include, but are not limited to: microcode, device drivers, redundant processing units, external disk drive arrays, RAID systems, tape drives, and data archival storage systems, etc.

In certain embodiments, node 100 has the architecture of computing node 710. In certain embodiments, node 100 is part of a cloud environment. In certain alternative embodiments, node 100 is not part of a cloud environment.

### Cloud Embodiments

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

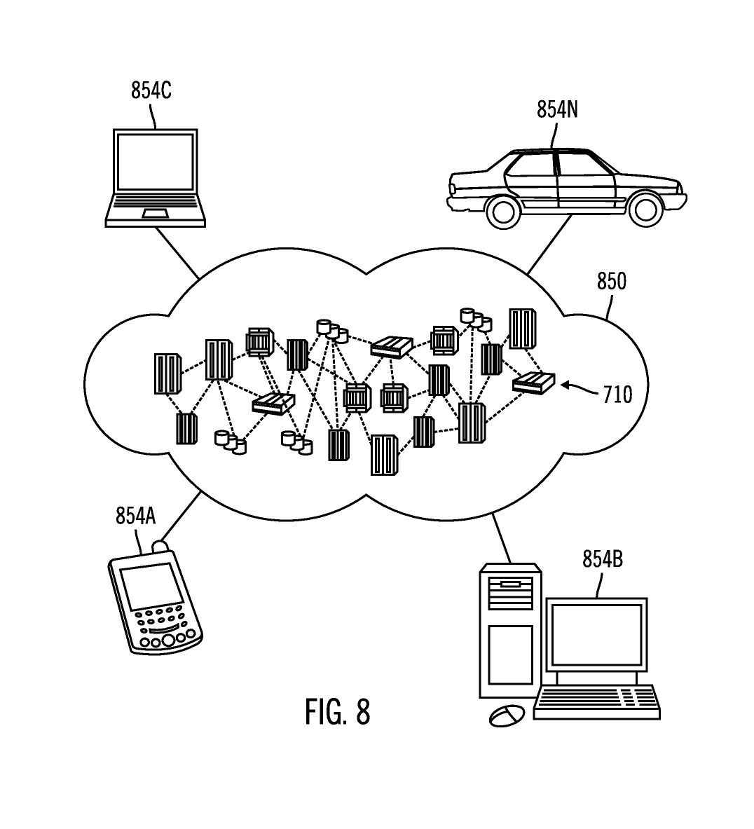

Referring now to FIG. 8, illustrative cloud computing environment 850 is depicted. As shown, cloud computing environment 850 comprises one or more cloud computing nodes 710 with which local computing devices used by cloud consumers, such as, for example, personal digital assistant (PDA) or cellular telephone 854A, desktop computer 854B, laptop computer 854C, and/or automobile computer system 854N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 8 are intended to be illustrative only and that computing nodes 710 and cloud computing environment 850 can communicate with any type of computerized device over any type of network and/or network addressable connection (e.g., using a web browser).

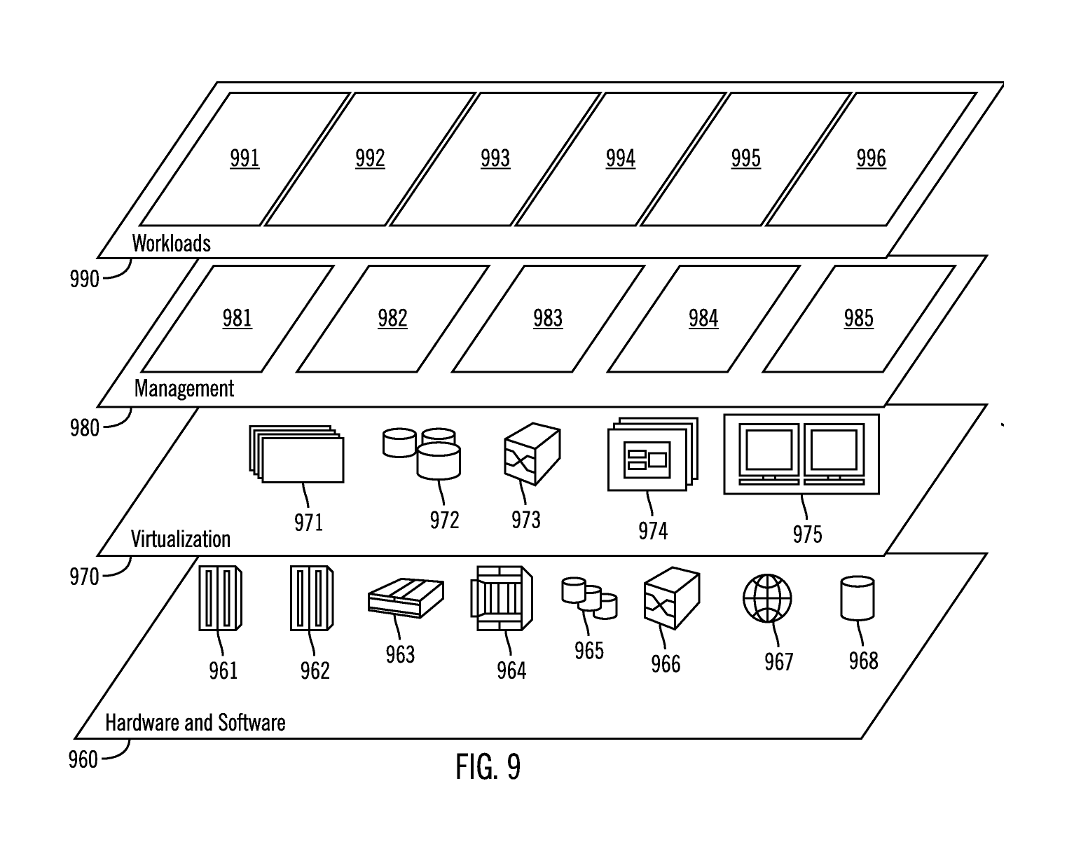

Referring now to FIG. 9, a set of functional abstraction layers provided by cloud computing environment 850 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 960 includes hardware and software components. Examples of hardware components include: mainframes 961; RISC (Reduced Instruction Set Computer) architecture based servers 962; servers 963; blade servers 964; storage devices 965; and networks and networking components 966. In some embodiments, software components include network application server software 967 and database software 968.

Virtualization layer 970 provides an abstraction layer from which the following examples of virtual entities may be provided: virtual servers 971; virtual storage 972; virtual networks 973, including virtual private networks; virtual applications and operating systems 974; and virtual clients 975.

In one example, management layer 980 may provide the functions described below. Resource provisioning 981 provides dynamic procurement of computing resources and other resources that are utilized to perform tasks within the cloud computing environment. Metering and Pricing 982 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 983 provides access to the cloud computing environment for consumers and system administrators. Service level management 984 provides cloud computing resource allocation and management such that required service levels are met. Service Level Agreement (SLA) planning and fulfillment 985 provide pre-arrangement for, and procurement of, cloud computing resources for which a future requirement is anticipated in accordance with an SLA.

Workloads layer 990 provides examples of functionality for which the cloud computing environment may be utilized. Examples of workloads and functions which may be provided from this layer include: mapping and navigation 991; software development and lifecycle management 992; virtual classroom education delivery 993; data analytics processing 994; transaction processing 995; and MDM processing 996.

Thus, in certain embodiments, software or a program, implementing MDM processing in accordance with embodiments described herein, is provided as a service in a cloud environment.

### Additional Embodiment Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-6. (canceled)

7. A computer program product, the computer program product comprising a computer readable storage medium having program code embodied therewith, the program code executable by at least one processor to perform:
assigning each customer record a single customer view identifier in a master data management repository;
using linkages to determine one or more suspect records for each customer record;
assigning a score to each customer record based on the linkages to the one or more suspect records, tag information associated with each customer record, and configuration information; and
generating a heat map to provide an indication of trustworthiness of the multiple records based on the reputation score associated with the origin of each record.

8. The computer program product of claim 7, wherein the program code is executable by the at least one processor to perform:
updating a single customer view identifier of each of the one or more suspect records to the single customer view identifier of the input record.

9. The computer program product of claim 7, wherein the tag includes an age of the record, and wherein the program code is executable by the at least one processor to perform:
receiving a request to generate a new heat map based on the reputation score and the age;
receiving a weight for each of the reputation score and the age; and
generating the new heat map while taking into account the weight for each of the reputation score and the age.

10. The computer program product of claim 7, wherein the program code is executable by the at least one processor to perform:
selecting a subset of customer records based on the reputation score associated with each of the customer records; and
performing analytic processing on the selected customer records.

11. The computer program product of claim 7, wherein the program code is executable by the at least one processor to perform:
determining whether to allow access to a customer record based on the reputation score associated with that customer record and based on the user requesting the access.

12. The computer program product of claim 7, wherein a Software as a Service (SaaS) is configured to perform the computer program product operations.

13. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more memories, to perform:
assigning each customer record a single customer view identifier in a master data management repository;
using linkages to determine one or more suspect records for each customer record;
assigning a score to each customer record based on the linkages to the one or more suspect records, tag information associated with each customer record, and configuration information; and
generating a heat map to provide an indication of trustworthiness of the multiple records based on the reputation score associated with the origin of each record.

14. The computer system of claim 13, wherein the operations further comprise:
updating a single customer view identifier of each of the one or more suspect records to the single customer view identifier of the input record.

15. The computer system of claim 13, wherein the tag includes an age of the record and wherein the operations further comprise:
receiving a request to generate a new heat map based on the reputation score and the age;
receiving a weight for each of the reputation score and the age; and
generating the new heat map while taking into account the weight for each of the reputation score and the age.

16. The computer system of claim 13, wherein the operations further comprise:
selecting a subset of customer records based on the reputation score associated with each of the customer records; and
performing analytic processing on the selected customer records.

17. The computer system of claim 13, wherein the operations further comprise:
determining whether to allow access to a customer record based on the reputation score associated with that customer record and based on the user requesting the access.

18. The computer system of claim 9, wherein a Software as a Service (SaaS) is configured to perform the system operations.
